(19) United States
(12) Patent Application Publication
(10) Pub. No.: US 2026/0233516 A1
(43) Pub. Date: Aug. 13, 2026

(54) Liquid Discharge Apparatus And Control Method Of Liquid Discharge Apparatus

(71) Applicant: SEIKO EPSON CORPORATION, Tokyo (JP)

(72) Inventor: Yoshitaka MATSUBARA, Shiojiri (JP)

(21) Appl. No.: 19/531,942

(22) Filed: Feb. 6, 2026

(30) Foreign Application Priority Data
Feb. 7, 2025 (JP) 2025-019075

(51) Int. Cl. B41J 2/045

(52) U.S. Cl. CPC B41J 2/04588; B41J 2/04541; B41J 2/04581; B41J 2/04596

(57) ABSTRACT

A liquid discharge apparatus includes a first discharge section, a second discharge section positioned adjacent to one side of the first discharge section, and a third discharge section positioned adjacent to another side of the first discharge section. In a unit period, a first amount of liquid is discharged from the first discharge section when a first drive signal is supplied to the first to the third discharge section. In the unit period, a second amount of liquid is discharged from the first discharge section when the first drive signal is supplied to the first discharge section and a second drive signal is supplied to the second and third discharge sections. A potential of the first and second drive signal is set so that a ratio of the second amount to the first amount is equal to or greater than 0.9 and equal to or less than 1.1.

The present application is based on, and claims priority from JP Application Serial Number 2025-019075, filed February 7, 2025, the disclosure of which is hereby incorporated by reference herein in its entirety.

### BACKGROUND

### 1. Technical Field

The present disclosure relates to a liquid discharge apparatus and a control method of the liquid discharge apparatus.

### 2. Related Art

A liquid discharge apparatus that prints an image by causing a plurality of nozzles to discharge a liquid such as ink by using a piezoelectric element is known. For example, a liquid discharge apparatus includes a liquid discharge head including a plurality of discharge sections. Each of the discharge sections includes a nozzle that discharges ink, a pressure chamber that communicates with the nozzle, and a piezoelectric element that applies a pressure fluctuation to the ink in the pressure chamber according to a drive signal. In this type of liquid discharge apparatus, a drive method of supplying a minute vibration pulse that applies the pressure fluctuation to the ink in the pressure chamber without discharging the ink from the nozzle to a piezoelectric element corresponding to a nozzle that does not discharge the ink is proposed. For example, JP-A-2010-125707 discloses a liquid discharge apparatus that supplies a preliminary vibration drive pulse for generating pressure vibration to a piezoelectric element that corresponds to a nozzle that does not discharge ink, to the extent that the ink is not discharged from the nozzle.

In a liquid discharge apparatus having a plurality of nozzles, there is a case where, when ink is discharged from one nozzle of a plurality of nozzles, the discharge amount of ink from the one nozzle differs depending on whether or not the nozzles adjacent to both sides of the one nozzle discharge ink at the same timing. There is a concern that the image quality may be deteriorated when the discharge amount of the ink from one nozzle differs depending on whether or not the nozzles adjacent to both sides of one nozzle among the plurality of nozzles discharge the ink at the same timing as the one nozzle. Therefore, in the liquid discharge apparatus, it is desired to suppress the difference in the discharge amount of liquid from the one nozzle depending on whether or not the nozzles adjacent to both sides of one nozzle among the plurality of nozzles discharge the liquid at the same timing as the one nozzle.

### SUMMARY

According to an aspect of the present disclosure, there is provided a liquid discharge apparatus including: a liquid discharge head that includes a plurality of discharge sections each having a nozzle that discharges a liquid, a pressure chamber which communicates with the nozzle, and a piezoelectric element which applies a pressure fluctuation to a liquid in the pressure chamber according to a drive signal; and a drive signal generation section that generates the drive signal, in which the plurality of discharge sections include a first discharge section, a second discharge section positioned adjacent to one side of the first discharge section, and a third discharge section positioned adjacent to another side of the first discharge section, the drive signal includes a first drive signal supplied to a discharge section that discharges a liquid from the nozzle, a second drive signal supplied to a discharge section that does not discharge a liquid from the nozzle, the first drive signal includes a discharge element that is an element of potential change for displacing the piezoelectric element so that a liquid is discharged from the nozzle, and the second drive signal includes a first potential maintenance element that maintains a potential so that the piezoelectric element is maintained at a predetermined displacement amount in a period corresponding to a period of the discharge element, in a unit period, a first amount of liquid is discharged from the nozzle of the first discharge section when the first drive signal is supplied to the first discharge section, the second discharge section, and the third discharge section, in the unit period, a second amount of liquid is discharged from the nozzle of the first discharge section when the first drive signal is supplied to the first discharge section and the second drive signal is supplied to the second discharge section and the third discharge section, and a potential of the first potential maintenance element is set so that a ratio of the second amount to the first amount is equal to or greater than 0.9 and equal to or less than 1.1.

According to another aspect of the present disclosure, there is provided a control method of a liquid discharge apparatus including a liquid discharge head that includes a plurality of discharge sections each having a nozzle that discharges a liquid, a pressure chamber which communicates with the nozzle, and a piezoelectric element which applies a pressure fluctuation to a liquid in the pressure chamber according to a drive signal, and a drive signal generation section that generates the drive signal, in which the plurality of discharge sections include a first discharge section, a second discharge section positioned adjacent to one side of the first discharge section, and a third discharge section positioned adjacent to another side of the first discharge section, in which the drive signal includes a first drive signal supplied to a discharge section that discharges a liquid from the nozzle, and a second drive signal supplied to a discharge section that does not discharge a liquid from the nozzle, the first drive signal includes a discharge element that is an element of potential change for displacing the piezoelectric element so that a liquid is discharged from the nozzle, the second drive signal includes a first potential maintenance element that maintains a potential so that the piezoelectric element is maintained at a predetermined displacement amount in a period corresponding to a period of the discharge element, in a unit period, a first amount of liquid is discharged from the nozzle of the first discharge section when the first drive signal is supplied to the first discharge section, the second discharge section, and the third discharge section, in the unit period, a second amount of liquid is discharged from the nozzle of the first discharge section when the first drive signal is supplied to the first discharge section and the second drive signal is supplied to the second discharge section and the third discharge section, and a potential of the first potential maintenance element is set so that a ratio of the second amount to the first amount is equal to or greater than 0.9 and equal to or less than 1.1.

### BRIEF DESCRIPTION OF THE DRAWINGS

FIG. 1 is a block diagram illustrating an example of a configuration of a liquid discharge apparatus according to an embodiment of the present disclosure.

FIG. 2 is a configuration diagram schematically illustrating the liquid discharge apparatus.

FIG. 3 is an explanatory diagram for describing a schematic structure of a head unit.

FIG. 4 is a block diagram illustrating an example of a configuration of the head unit.

FIG. 5 is a timing chart illustrating an example of an operation of the liquid discharge apparatus in a unit period.

FIG. 6 is a diagram for describing structural crosstalk.

FIG. 7 is an explanatory diagram for describing a relationship between a drive signal supplied to a discharge section that does not discharge ink and a crosstalk rate.

### DESCRIPTION OF EMBODIMENTS

Hereinafter, embodiments for carrying out the present disclosure will be described with reference to the accompanying drawings. However, in each drawing, a dimension and a scale of each section are appropriately different from actual ones. Further, since the embodiments which will be described below are suitable specific examples of the present disclosure, various technically preferable limitations are attached. However, the scope of the present disclosure is not limited to the embodiments unless the following description particularly limits the present disclosure.

### 1. Embodiment

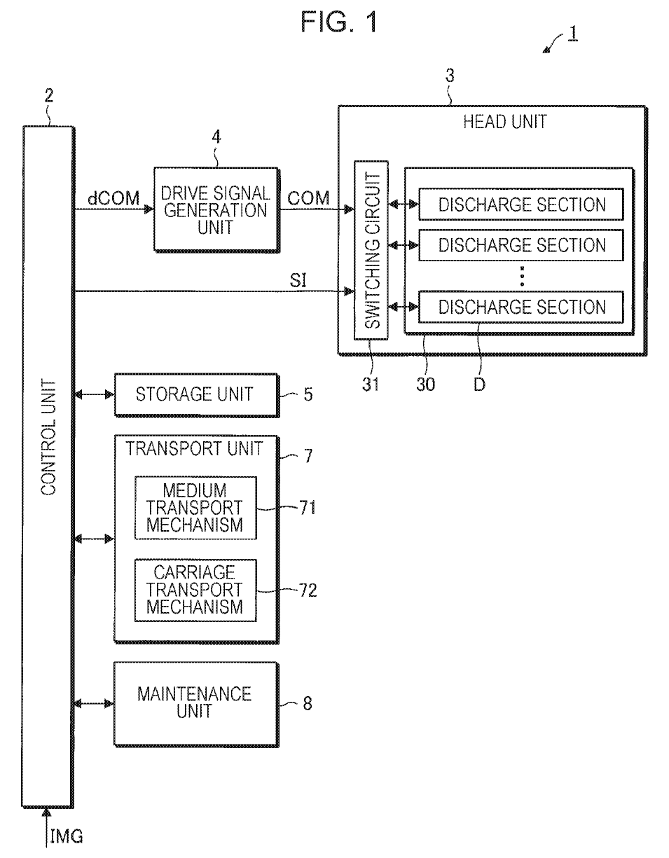

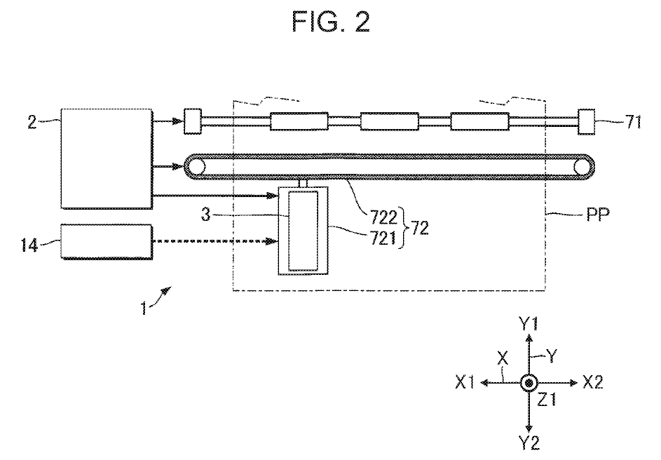

First, a configuration of a liquid discharge apparatus 1 according to the present embodiment will be described with reference to FIG. 1. In the present embodiment, a case where the liquid discharge apparatus 1 is an ink jet printer that discharges an ink to a medium to form an image is assumed as an example. In the present embodiment, the ink is an example of a "liquid". In the present embodiment, a recording paper sheet PP illustrated in FIG. 2 to be described below is assumed as the medium.

FIG. 1 is a block diagram illustrating an example of a configuration of the liquid discharge apparatus 1 according to the embodiment of the present disclosure.

For example, print data IMG indicating an image to be formed by the liquid discharge apparatus 1 is supplied to the liquid discharge apparatus 1 from a host computer such as a personal computer and a digital camera. The liquid discharge apparatus 1 performs a printing process of forming the image indicated by the print data IMG supplied from the host computer on the medium.

The liquid discharge apparatus 1 includes a control unit 2 that controls each section of the liquid discharge apparatus 1, a head unit 3 that is provided with a discharge section D that discharges ink, and a drive signal generation unit 4 that generates a plurality of drive signals COM for driving the discharge section D. Further, the liquid discharge apparatus 1 includes a storage unit 5 that stores various information such as print data IMG and a control program of the liquid discharge apparatus 1. Further, the liquid discharge apparatus 1 includes a transport unit 7 for changing a relative position of the recording paper sheet PP with respect to the head unit 3, and a maintenance unit 8 that executes a maintenance process for maintaining the discharge section D provided in the head unit 3. The head unit 3 is an example of a "liquid discharge head", and the drive signal generation unit 4 is an example of a "drive signal generation section".

In the present embodiment, it is assumed that the head unit 3 and the drive signal generation unit 4 correspond to each other. For example, the liquid discharge apparatus 1 may include the plurality of head units 3 and the plurality of drive signal generation units 4 that correspond to the plurality of head units 3 on a one-to-one basis. Alternatively, the liquid discharge apparatus 1 may include one head unit 3 and one drive signal generation unit 4 corresponding to the one head unit 3.

In the present embodiment, it is assumed that the liquid discharge apparatus 1 includes four head units 3 and four drive signal generation units 4 that correspond to the four head units 3 on a one-to-one basis. However, hereinafter, for convenience of description, as illustrated in FIG. 1, there is a case where a description will be given by focusing on one head unit 3 among the four head units 3 and one drive signal generation unit 4 provided corresponding to one head unit 3 among the four drive signal generation units 4.

The control unit 2 is configured with one or a plurality of central processing units (CPU). The control unit 2 may be configured with a programmable logic device such as a field-programmable gate array (FPGA), instead of the CPU or in addition to the CPU. Further, the control unit 2 generates a signal for controlling an operation of each section of the liquid discharge apparatus 1, such as a print signal SI and a waveform designation signal dCOM, by operating according to a control program stored in the storage unit 5.

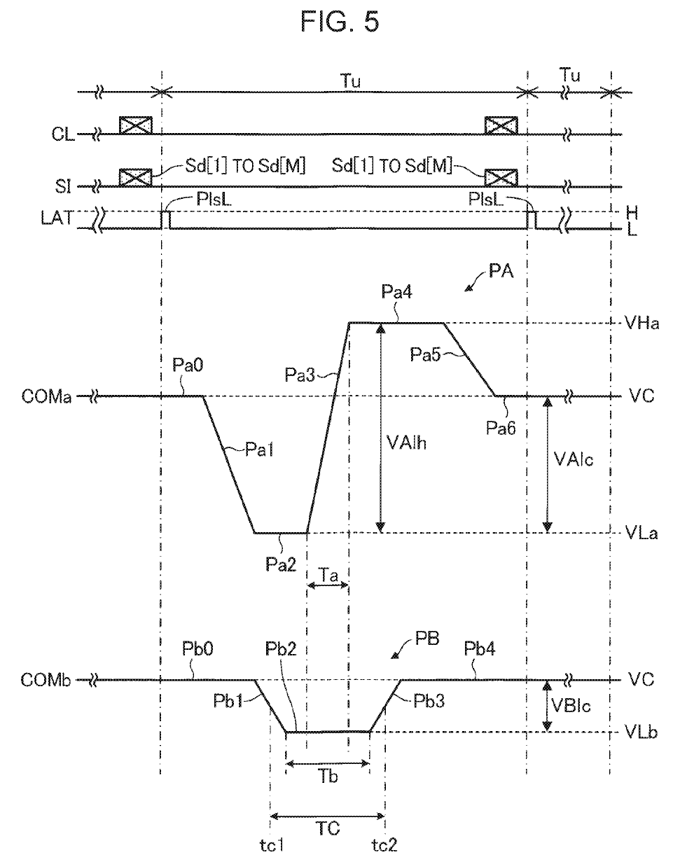

Herein, the waveform designation signal dCOM is a digital signal that defines each of waveforms of the plurality of drive signals COM. In addition, each drive signal COM is an analog signal for driving the discharge section D. In the present embodiment, as illustrated in FIG. 5 and the like to be described below, it is assumed that the plurality of drive signals COM include a drive signal COMa, a drive signal COMb, and the like. The print signal SI is a digital signal for designating a type of operation of the discharge section D. Specifically, the print signal SI is a signal for designating the type of operation of the discharge section D by designating whether or not to supply each drive signal COM to the discharge section D.

The drive signal generation unit 4 includes, for example, a digital analog converter (DAC), and generates the plurality of drive signals COM based on the waveform designation signal dCOM supplied from the control unit 2. For example, each of the plurality of drive signals COM generated by the drive signal generation unit 4 includes a waveform defined by the waveform designation signal dCOM. The drive signal generation unit 4 outputs the plurality of drive signals COM generated based on the waveform designation signal dCOM to a switching circuit 31 included in the head unit 3.

The storage unit 5 is configured to include one or both of a volatile memory such as a random access memory (RAM), and a non-volatile memory such as a read only memory (ROM), an electrically erasable programmable read-only memory (EEPROM), or a programmable ROM (PROM). The storage unit 5 may be included in the control unit 2.

The head unit 3 includes a recording head 30 and a switching circuit 31.

The recording head 30 includes M discharge sections D. A value of M is a natural number of 3 or more. Hereinafter, among the M discharge sections D provided in the recording head 30, an m-th discharge section D may be referred to as a discharge section D[m]. In this case, the variable m is a natural number that satisfies "3 ≤ m ≤ M". In addition, hereinafter, when a component, a signal, or the like of the liquid discharge apparatus 1 corresponds to the discharge section D[m] among the M discharge sections D, a suffix [m] may be added to reference numerals for representing the component, the signal, or the like.

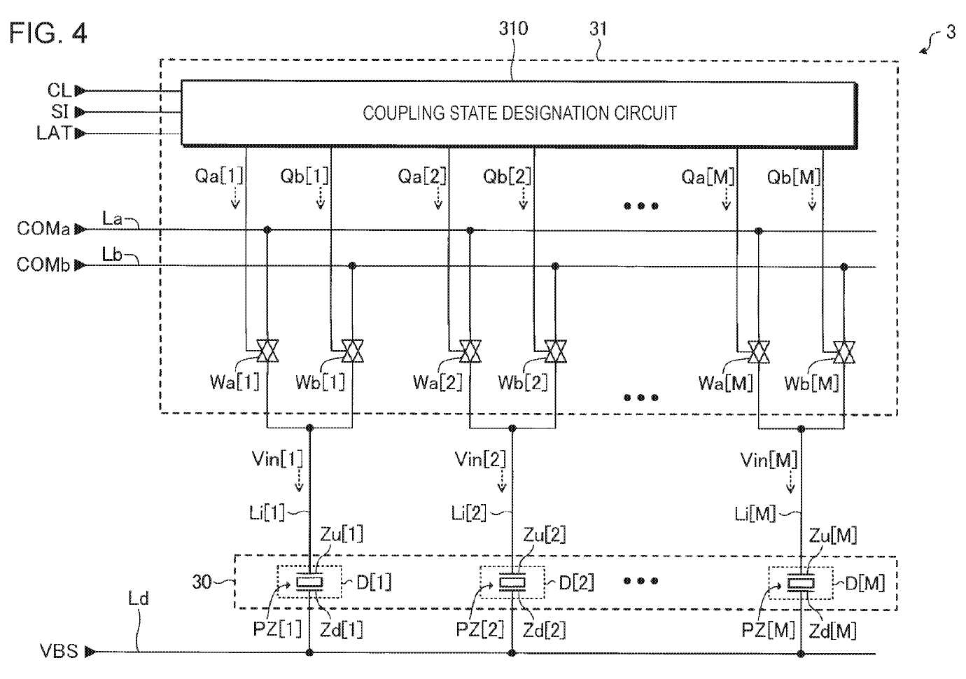

The switching circuit 31 switches whether or not to supply each drive signal COM to the discharge section D[m], based on the print signal SI. Hereinafter, as illustrated in FIG. 4 and the like to be described later, the drive signal COM supplied to the discharge section D[m] among the plurality of drive signals COM will be referred to as an individual drive signal Vin[m] in some cases.

As described above, in the present embodiment, the liquid discharge apparatus 1 executes the printing process. When the printing process is executed, the control unit 2 generates a signal for controlling the head unit 3 such as the print signal SI based on the print data IMG. In addition, the control unit 2 generates a signal for controlling the drive signal generation unit 4, such as the waveform designation signal dCOM, when the printing process is executed. In addition, the control unit 2 generates a signal for controlling the transport unit 7 when the printing process is executed. Therefore, in the printing process, the control unit 2 adjusts the presence or absence of discharge of inks from the discharge section D[m], the discharge amount of ink, a discharging timing of the inks, and the like while controlling the transport unit 7 to change a relative position of the recording paper sheet PP with respect to the head unit 3. As described above, the control unit 2 controls each section of the liquid discharge apparatus 1 so that an image corresponding to the print data IMG is formed at the recording paper sheet PP.

The transport unit 7 includes a carriage transport mechanism 72 for reciprocating a carriage 721 and a medium transport mechanism 71 for transporting the recording paper sheet PP. The carriage 721 will be described below in FIG. 2.

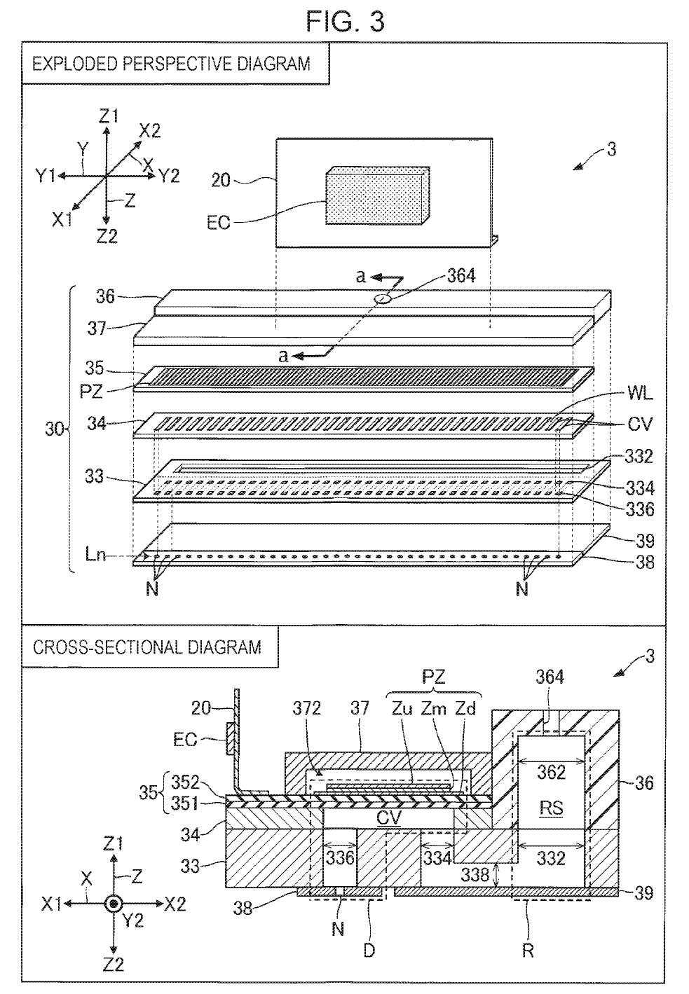

Further, as described above, in the present embodiment, the liquid discharge apparatus 1 executes the maintenance process. For example, the maintenance process includes flushing processing of discharging inks from the discharge section D, wiping processing of wiping off a foreign matter such as an ink adhering to the vicinity of a nozzle N of the discharge section D with a wiper, and pumping processing of suctioning the ink in the discharge section D with a tube pump or the like. The nozzle N will be described below in FIG. 3.

The maintenance unit 8 includes a discharged ink receiving section for receiving the discharged ink when the ink in the discharge section D is discharged, a wiper for wiping off a foreign matter such as an ink adhering to the vicinity of the nozzle N of the discharge section D, and a tube pump for suctioning the ink, air bubbles, and the like in the discharge section D, in the flushing processing. The discharged ink receiving section, the wiper, and the tube pump are not illustrated.

Next, a schematic overall configuration of the liquid discharge apparatus 1 will be described with reference to FIG. 2.

FIG. 2 is a configuration diagram schematically illustrating the liquid discharge apparatus 1. As illustrated in FIG. 2, in the present embodiment, it is assumed that the liquid discharge apparatus 1 is a serial printer as an example.

As illustrated in FIG. 2, the liquid discharge apparatus 1 includes a liquid container 14 that stores ink, in addition to the elements described in FIG. 1. As the liquid container 14, for example, a cartridge that can be attached to and detached from the liquid discharge apparatus 1, a bag-shaped ink pack formed of a flexible film, an ink tank that can be replenished with ink, or the like can be employed. A type of ink to be stored in the liquid container 14 is not particularly limited, and is selected in any desired way.

The medium transport mechanism 71 transports the recording paper sheet PP in a Y2 direction along a Y axis under the control of the control unit 2. Hereinafter, a Y1 direction and the Y2 direction opposite to the Y1 direction are collectively referred to as a direction along the Y axis. In addition, hereinafter, an X1 direction along an X axis that intersects the Y axis and an X2 direction opposite to the X1 direction are collectively referred to as a direction along the X axis. In addition, hereinafter, a Z1 direction along a Z axis that intersects the X axis and the Y axis and a Z2 direction opposite to the Z1 direction are collectively referred to as a direction along the Z axis. In the present embodiment, as an example, description will be performed while assuming that the X axis, the Y axis, and the Z axis are orthogonal to each other. However, the present disclosure is not limited to such an aspect. The X axis, the Y axis, and the Z axis may intersect each other. In the present embodiment, the Z2 direction corresponds to an ink discharge direction from the discharge section D[m].

The carriage transport mechanism 72 reciprocates the head unit 3 in the X1 direction and the X2 direction under the control of the control unit 2. As illustrated in FIG. 2, the carriage transport mechanism 72 includes the substantially box-shaped carriage 721 accommodating the head unit 3 and an endless belt 722 to which the carriage 721 is fixed. The liquid container 14 may be stored in the carriage 721 together with the head unit 3.

Next, a schematic structure of the head unit 3 will be described with reference to FIG. 3.

FIG. 3 is an explanatory diagram for describing the schematic structure of the head unit 3. The upper part of FIG. 3 is an exploded perspective diagram of the head unit 3, and the lower part of FIG. 3 is a cross-sectional diagram taken along the line a-a illustrated in the exploded perspective diagram. The a-a cross section is parallel to the XZ plane, and passes through an introduction port 364 described below.

As illustrated in FIG. 3, the head unit 3 includes a wiring substrate 20 on which an electronic component EC is mounted, a flow path substrate 33, a pressure chamber substrate 34, a vibration plate 35, and M piezoelectric elements PZ, a case 36, a sealing plate 37, a nozzle substrate 38, and a vibration absorber 39. The electronic component EC includes, for example, an electric circuit such as the switching circuit 31. For example, the recording head 30 is electrically coupled to the switching circuit 31 or the like via the wiring substrate 20. As illustrated in the exploded perspective diagram of FIG. 3, the recording head 30 includes, for example, a flow path substrate 33, a pressure chamber substrate 34, a vibration plate 35, M piezoelectric elements PZ, a case 36, a sealing plate 37, a nozzle substrate 38, and a vibration absorber 39.

Here, the pressure chamber substrate 34, the vibration plate 35, the M piezoelectric elements PZ, the case 36, and the sealing plate 37 are installed in a region located in the Z1 direction from the flow path substrate 33. On the other hand, the nozzle substrate 38 and the vibration absorber 39 are installed in a region located in the Z2 direction from the flow path substrate 33. In addition, the wiring substrate 20 is provided on a surface of the vibration plate 35 in the Z1 direction, for example. Each element of the head unit 3 is generally a plate-shaped member elongated in the direction along the Y axis, and is joined to each other with an adhesive, for example.

As illustrated in the exploded perspective diagram of FIG. 3, the nozzle substrate 38 is a plate-shaped member in which M nozzles N arranged along the Y axis are formed. Each of the nozzles N is a through-hole through which ink passes. The flow path substrate 33, the pressure chamber substrate 34, and the nozzle substrate 38 are formed by processing, for example, a silicon single crystal substrate by a semiconductor manufacturing technology such as etching. Meanwhile, a material or a manufacturing method of each element of the head unit 3 is optional. The direction of the Y axis can also be referred to as a direction in which the M nozzles N are arranged. Hereinafter, the M nozzles N arranged along the Y axis are referred to as a nozzle row Ln.

The flow path substrate 33 is a plate-shaped member for forming a flow path for inks. As illustrated in FIG. 3, the flow path substrate 33 is formed with an opening portion 332, M supply flow paths 334, and M communication flow paths 336. The opening portion 332 is a through-hole that is continuous over the M nozzles N along the Y axis in a plan view from the direction along the Z axis. That is, the opening portion 332 is a long through-hole extending in the direction along the Y axis. The supply flow path 334 and the communication flow path 336 are through-holes individually formed for each of the nozzles N. As illustrated in the cross-sectional diagram in FIG. 3, a relay flow path 338 over the M supply flow paths 334 is formed at a surface of the flow path substrate 33 in the Z2 direction. The relay flow path 338 is a flow path that allows the opening portion 332 and the M supply flow paths 334 to communicate with each other.

The pressure chamber substrate 34 is a plate-shaped member in which M pressure chambers CV respectively corresponding to the M nozzles N are formed. The pressure chamber CV is located between the flow path substrate 33 and the vibration plate 35, and is a space called a cavity for applying pressure to an ink filled in the pressure chamber CV. The M pressure chambers CV are partitioned by the partition wall WL of the pressure chamber substrate 34 and are arranged in the direction along the Y axis. Each pressure chamber CV is configured with a hole that opens at both surfaces of the pressure chamber substrate 34, and has a long shape extending in the direction along the X axis. An end of each pressure chamber CV in the X2 direction communicates with the corresponding supply flow path 334 among the M supply flow paths 334. On the other hand, an end of each pressure chamber CV in the X1 direction communicates with the corresponding communication flow path 336 among the M communication flow paths 336.

The vibration plate 35 is installed on a surface of the pressure chamber substrate 34 in a direction opposite to a surface facing the flow path substrate 33. The vibration plate 35 is a plate-shaped member that is elastically deformable. As illustrated in the cross-sectional diagram of FIG. 3, the vibration plate 35 includes an insulating film 352 and an elastic film 351 laminated in the direction along the Z axis. The insulating film 352 is located in a direction opposite to the pressure chamber substrate 34 when viewed from the elastic film 351. The elastic film 351 is formed of, for example, silicon oxide. The insulating film 352 is formed of, for example, zirconium oxide.

As can be understood from FIG. 3, the flow path substrate 33 and the vibration plate 35 face each other at an interval inside each of the pressure chambers CV. The vibration plate 35 forms a part of a wall surface of the pressure chamber CV. An ink stored in a liquid storage chamber RS which will be described later branches from the relay flow path 338 to each supply flow path 334, and is supplied to and filled into the M pressure chambers CV in parallel.

As illustrated in FIG. 3, the M piezoelectric elements PZ respectively corresponding to the M nozzles N are installed on a surface of the vibration plate 35 in a direction opposite to the pressure chamber substrate 34. For example, for any m from 1 to M, the nozzle N[m] corresponds to the piezoelectric element PZ[m]. The nozzle N corresponding to the piezoelectric element PZ is the nozzle N communicating with the pressure chamber CV that partially or entirely overlaps with the piezoelectric element PZ in a plan view in the Z2 direction. Each of the piezoelectric elements PZ is an actuator that is deformed by the supply of the drive signal COM, and is formed in a long shape in a direction along the X axis. The M piezoelectric elements PZ are arranged in the direction along the Y axis to correspond to the M pressure chambers CV. When the drive signal COM is supplied to the piezoelectric element PZ and the vibration plate 35 vibrates in conjunction with deformation of the piezoelectric element PZ, pressure in the pressure chamber CV fluctuates. As the pressure in the pressure chamber CV fluctuates, the ink filled in the pressure chamber CV passes through the communication flow path 336 and the nozzle N, and is discharged. That is, the piezoelectric element PZ is a drive element that discharges the ink in the pressure chamber CV from the nozzle N by vibrating the vibration plate 35.

In the present embodiment, as illustrated in FIG. 5 which will be described later, the drive signal COMb for not discharging the ink in the nozzle N is supplied to the piezoelectric element PZ corresponding to the nozzle N that does not discharge the ink. When the drive signal COMb is supplied to the piezoelectric element PZ, the vibration plate 35 may vibrate in conjunction with the deformation of the piezoelectric element PZ and the pressure in the pressure chamber CV may fluctuate. However, in the deformation of the piezoelectric element PZ by the drive signal COMb, the ink in the nozzle N only vibrates, and the ink is not discharged from the nozzle N. In the following description, the vibration that causes the ink in the nozzle N to vibrate to the extent that the ink in the nozzle N is not discharged may be described as a micro-vibration.

As illustrated in the cross-sectional diagram of FIG. 3, the piezoelectric element PZ has an upper electrode Zu, a lower electrode Zd, and a piezoelectric body Zm provided between the upper electrode Zu and the lower electrode Zd. For example, the drive signal COM is supplied to the upper electrode Zu, and a bias voltage signal VBS having a constant potential illustrated in FIG. 4 which will be described later is supplied to the lower electrode Zd. Further, the pressure chamber CV is provided in the Z2 direction of a piezoelectric element PZ.

In the cross-sectional diagram of FIG. 3, in order to avoid the drawing from being complicated, a wiring which is coupled to the upper electrode Zu and supplies the drive signal COM to the upper electrode Zu, and a wiring which is coupled to the lower electrode Zd and supplies the bias voltage signal VBS to the lower electrode Zd are not illustrated. In the present embodiment, a case is assumed in which the drive signal COM is supplied to the upper electrode Zu and the bias voltage signal VBS is supplied to the lower electrode Zd. Meanwhile, the bias voltage signal VBS may be supplied to the upper electrode Zu and the drive signal COM may be supplied to the lower electrode Zd.

Here, in the present embodiment, as an example, it is assumed that the piezoelectric element PZ is displaced in the Z2 direction by changing a potential of the individual drive signal Vin[m] supplied to the discharge section D[m] from a low potential to a high potential. That is, in the present embodiment, it is assumed that the volume of the pressure chamber CV provided in the discharge section D[m] is decreased when the potential of the individual drive signal Vin[m] supplied to the discharge section D[m] is high, in comparison with a case where the potential is low.

As illustrated in FIG. 3, the case 36 is, for example, a structure manufactured by injection molding of a resin material, and is fixed to a surface of the flow path substrate 33 in the Z1 direction. As illustrated in the cross-sectional diagram of FIG. 3, the case 36 is formed with an accommodation section 362 and an introduction port 364. The accommodation section 362 is a recess section having a shape corresponding to the opening portion 332 of the flow path substrate 33. The introduction port 364 is a through-hole that communicates with the accommodation section 362. A space of the opening portion 332 of the flow path substrate 33 and the accommodation section 362 of the case 36 functions as the liquid storage chamber RS which is a reservoir which stores inks to be supplied to the M pressure chambers CV. The ink supplied from the liquid container 14 and passing through the introduction port 364 is stored in the liquid storage chamber RS.

The sealing plate 37 has a structure that protects the M piezoelectric elements PZ from the outside air and reinforces the mechanical strength of the pressure chamber substrate 34 and the vibration plate 35. The sealing plate 37 is fixed to a surface of the vibration plate 35 with, for example, an adhesive. As illustrated in the cross-sectional diagram of FIG. 3, the sealing plate 37 has a recess section on a surface facing the vibration plate 35. A sealing space 372 is formed by fixing the sealing plate 37 to the surface of the vibration plate 35. The M piezoelectric elements PZ are provided in the sealing space 372.

The vibration absorber 39 absorbs the pressure fluctuation in the liquid storage chamber RS. That is, the vibration absorber 39 absorbs the vibration of the inks stored in the liquid storage chamber RS. For example, the vibration absorber 39 includes a flexible sheet member that can be elastically deformed. Specifically, the vibration absorber 39 is installed on a surface of the flow path substrate 33 in the Z2 direction so that a bottom surface of the liquid storage chamber RS is formed by closing the opening portion 332 of the flow path substrate 33, the relay flow path 338, and the plurality of supply flow paths 334.

Next, an outline of the head unit 3 will be described with reference to FIG. 4.

FIG. 4 is a block diagram illustrating an example of a configuration of the head unit 3.

As described in FIG. 1, the head unit 3 includes a recording head 30 and a switching circuit 31. In addition, the head unit 3 has wiring La to which the drive signal COMa is supplied from the drive signal generation unit 4 and wiring Lb to which the drive signal COMb is supplied from the drive signal generation unit 4. Further, the head unit 3 includes a wiring Li[m] that supplies the individual drive signal Vin[m] to the discharge section D[m] and a wiring Ld to which the bias voltage signal VBS is supplied. The drive signal COMa is an example of a "first drive signal", and the drive signal COMb is an example of a "second drive signal".

The switching circuit 31 includes M switches Wa[1] to Wa[M] that correspond to the M discharge sections D[1] to D[M] in a one-to-one manner, M switches Wb[1] to Wb[M] that correspond to the M discharge sections D[1] to D[M] in a one-to-one manner, and a coupling state designation circuit 310. The coupling state designation circuit 310 designates a coupling state of each of the M switches Wa and the M switches Wb. For example, the coupling state designation circuit 310 generates coupling state designation signals Qa[m] and Qb[m] based on at least a part of the signals of the print signal SI and the latch signal LAT supplied from the control unit 2. The coupling state designation signal Qa[m] is a signal for designating ON or OFF of the switch Wa[m], and the coupling state designation signal Qb[m] is a signal for designating ON or OFF of the switch Wb[m].

The switch Wa[m] switches conduction and non-conduction between the wiring La and the upper electrode Zu[m] of the piezoelectric element PZ[m] provided in the discharge section D[m], based on the coupling state designation signal Qa[m]. That is, the switch Wa[m] switches conduction and non-conduction between the wiring La and the wiring Li[m] coupled to the upper electrode Zu[m], based on the coupling state designation signal Qa[m]. In the present embodiment, the switch Wa[m] is turned on when the coupling state designation signal Qa[m] is at a high level, and is turned off when the coupling state designation signal Qa[m] is at a low level. When the switch Wa[m] is turned on, the drive signal COMa supplied to the wiring La is supplied to the upper electrode Zu[m] of the discharge section D[m] as the individual drive signal Vin[m] via the wiring Li[m].

The switch Wb[m] switches conduction and non-conduction between the wiring Lb and the upper electrode Zu[m] of the piezoelectric element PZ[m] provided in the discharge section D[m], based on the coupling state designation signal Qb[m]. That is, the switch Wb[m] switches conduction and non-conduction between the wiring Lb and the wiring Li[m] coupled to the upper electrode Zu[m], based on the coupling state designation signal Qb[m]. In the present embodiment, the switch Wb[m] is turned on when the coupling state designation signal Qb[m] is at a high level, and is turned off when the coupling state designation signal Qb[m] is at a low level. When the switch Wb[m] is turned on, the drive signal COMb supplied to the wiring Lb is supplied to the upper electrode Zu[m] of the discharge section D[m] as the individual drive signal Vin[m] via the wiring Li[m].

As described above, the individual drive signal Vin[m] is a signal supplied to the piezoelectric element PZ[m] of the discharge section D[m] via the switch Wa[m] or Wb[m] among the drive signals COMa and COMb.

Next, an operation of the liquid discharge apparatus 1 in a unit period Tu will be described with reference to FIG. 5.

FIG. 5 is a timing chart illustrating an example of the operation of the liquid discharge apparatus 1 in the unit period Tu. In the present embodiment, when the liquid discharge apparatus 1 performs the printing process, a printing process period including one or a plurality of unit periods Tu is set as an operation period of the liquid discharge apparatus 1. The liquid discharge apparatus 1 according to the present embodiment can drive each discharge section D for the printing process in each unit period Tu. The unit period Tu is, for example, a drive cycle of the M discharge sections D. In the present embodiment, it is assumed that one cycle of the plurality of drive signals COM is the unit period Tu.

The control unit 2 outputs the latch signal LAT having a pulse PlsL. Therefore, the control unit 2 defines the unit period Tu as a period from rising of the pulse PlsL to rising of the next pulse PlsL.

The print signal SI includes, for example, M individual designation signals Sd[1] to Sd[M] corresponding to the M discharge sections D[1] to D[M] on a one-to-one basis. The individual designation signal Sd[m] designates an aspect of driving of the discharge section D[m] in each unit period Tu when the liquid discharge apparatus 1 performs the printing process.

The control unit 2 supplies the print signal SI including the individual designation signals Sd[1] to Sd[M] to the coupling state designation circuit 310 in synchronization with the clock signal CL before each unit period Tu in which the printing process is executed. The coupling state designation circuit 310 generates the coupling state designation signals Qa[m] and Qb[m] based on the individual designation signal Sd[m] in the unit period Tu.

For example, by the individual designation signal Sd[m], the discharge section D[m] is designated to any one of the discharge section D that forms dots and the discharge section D that does not form dots in the unit period Tu in which the printing process is executed. The discharge section D that forms a dot is the discharge section D in which the piezoelectric element PZ of the discharge section D is driven so that an ink is discharged from the nozzle N of the discharge section D. In addition, the discharge section D that does not form a dot is the discharge section D in which the piezoelectric element PZ of the discharge section D is driven so that the ink is not discharged from the nozzle N of the discharge section D. The drive signal COMa is supplied as the individual drive signal Vin[m] to the discharge section D[m] that forms the dots, that is, the discharge section D[m] that discharges ink from the nozzle N. In addition, the drive signal COMb is supplied as the individual drive signal Vin[m] to the discharge section D[m] that does not form dots, that is, the discharge section D[m] that does not discharge ink from the nozzle N.

First, an outline of the drive signal COMa will be described.

The drive signal COMa includes a pulse PA, a waveform element Pa0 which is an element before the pulse PA, and a waveform element Pa6 which is an element after the pulse PA. For example, when the drive signal COMa is supplied to the wiring La, the waveform element Pa0, the pulse PA, and the waveform element Pa6 are supplied to the wiring La in the unit period Tu.

For example, the waveform element Pa0 is an element that maintains the potential of the drive signal COMa at the reference potential VC from the start of the unit period Tu to the start of the pulse PA. In addition, the waveform element Pa6 is an element that maintains the potential of the drive signal COMa at the reference potential VC from the end of the pulse PA until the end of the unit period Tu. The waveform element Pa0 is an example of a "first start potential maintenance element", and the waveform element Pa6 is an example of a "first end potential maintenance element".

The pulse PA is a pulse in which the potential of the drive signal COMa returns from the reference potential VC to the reference potential VC via the potential VLa and the potential VHa. The potential VLa is a potential lower than the reference potential VC, and is the lowest potential of the pulse PA. The potential VHa is a potential higher than the reference potential VC and is the highest potential of the pulse PA. That is, the reference potential VC is a potential between the potential VLa and the potential VHa. The potential VLa is an example of the "first potential", and the potential VHa is an example of the "second potential". Each of the reference potential VC, the potential VLa, and the potential VHa is determined based on, for example, the ink discharge characteristic by the discharge section D. Examples of the ink discharge characteristic include the amount of ink to be discharged and the speed of ink to be discharged.

For example, the pulse PA includes waveform elements Pa1, Pa2, Pa3, Pa4, and Pa5.

The waveform element Pa1 is an element after the waveform element Pa0, and is an expansion element for displacing the piezoelectric element PZ in the Z1 direction. In the expansion element, the potential of the drive signal COMa changes to expand a volume of the pressure chamber CV. For example, in the waveform element Pa1, the potential of the drive signal COMa changes from the reference potential VC to the potential VLa to drive the piezoelectric element PZ so as to expand the volume of the pressure chamber CV. When the volume of the pressure chamber CV expands, a surface of an ink in the nozzle N is pulled in the Z1 direction, which is a direction opposite to the discharge direction. Hereinafter, the pulling of the surface of the ink in the nozzle N in the direction opposite to the discharge direction may be referred to as a pull. In addition, hereinafter, the surface of the ink in the nozzle N may be referred to as a meniscus. The waveform element Pa1 is an example of an "expansion element".

The waveform element Pa2 is an element after the waveform element Pa1, and is a maintenance element for maintaining the position of the piezoelectric element PZ in the direction along the Z axis. For example, in the waveform element Pa2, the potential of the drive signal COMa is maintained in order to drive the piezoelectric element PZ so that the volume of the pressure chamber CV expanded by the waveform element Pa1 is maintained. Therefore, in the waveform element Pa2, the potential of the drive signal COMa is maintained at the potential VLa, which is the potential of the end point of the waveform element Pa1. The waveform element Pa2 is an example of an "expansion maintenance element".

The waveform element Pa3 is an element after the waveform element Pa2, and is a contraction element for displacing the piezoelectric element PZ in the Z2 direction. In the contraction element, the potential of the drive signal COMa changes to contract the volume of the pressure chamber CV. For example, in the waveform element Pa3, the potential of the drive signal COMa changes from the potential VLa to the potential VHa to drive the piezoelectric element PZ to contract the volume of the pressure chamber CV. When the volume of the pressure chamber CV is contracted, the surface of the ink in the nozzle N is pushed out in the Z2 direction, which is the discharge direction. As a result, the ink is discharged from the nozzle N. Hereinafter, the act of pushing the surface of the ink in the nozzle N in the discharge direction may be referred to as a push. The waveform element Pa3 is an example of a "discharge element".

The waveform element Pa4 is a maintenance element after the waveform element Pa3. For example, in the waveform element Pa4, the potential of the drive signal COMa is maintained at the potential VHa of the end point of the waveform element Pa3 to drive the piezoelectric element PZ to maintain the volume of the pressure chamber CV that is contracted by the waveform element Pa3.

The waveform element Pa5 is an expansion element after the waveform element Pa4. For example, in the waveform element Pa5, the potential of the drive signal COMa changes from the potential VHa to the reference potential VC to expand the volume of the pressure chamber CV maintained by the waveform element Pa4 to attenuate the residual vibration of the ink in the pressure chamber CV. The volume of the pressure chamber CV maintained by the waveform element Pa4 corresponds to the volume of the pressure chamber CV contracted by the waveform element Pa3.

As described above, the pulse PA is a so-called pull-push-pull waveform. However, the pulse PA is not limited to the pull-push-pull waveform. For example, the pulse PA may be a so-called pull-push waveform. In addition, as understood from FIG. 5, the waveform element Pa0 is an element before the waveform element Pa3, and the waveform element Pa6 is an element after the waveform element Pa3. In addition, the waveform element Pa1 is an element between the waveform element Pa0 and the waveform element Pa3, and the waveform element Pa2 is an element between the waveform element Pa1 and the waveform element Pa3.

Next, an outline of the drive signal COMb will be described.

The drive signal COMb includes a pulse PB, a waveform element Pb0 which is an element before the pulse PB, and a waveform element Pb4 which is an element after the pulse PB. For example, when the drive signal COMb is supplied to the wiring Lb, the waveform element Pb0, the pulse PB, and the waveform element Pb4 are supplied to the wiring Lb in the unit period Tu.

For example, the waveform element Pb0 is an element that maintains the potential of the drive signal COMb at the reference potential VC from the start of the unit period Tu to the start of the pulse PB. In addition, the waveform element Pb4 is an element that maintains the potential of the drive signal COMb at the reference potential VC from the end of the pulse PB until the end of the unit period Tu. The waveform element Pb0 is an example of a "start potential maintenance element" and a "second start potential maintenance element", and the waveform element Pb4 is an example of an "end potential maintenance element" and a "second end potential maintenance element".

The pulse PB is a pulse in which the potential of the drive signal COMb returns from the reference potential VC to the reference potential VC via the potential VLb. The potential VLb is a potential lower than the reference potential VC, and is the lowest potential of the pulse PB. The potential VLb is set so that, for example, the generation of so-called structural crosstalk in which the discharge amount of the ink from the first nozzle N differs due to whether or not the nozzles N adjacent to both sides of the first nozzle N among the plurality of nozzles N discharge the ink at the same timing as the first nozzle N is suppressed. Hereinafter, the nozzles N adjacent to both sides of the first nozzle N may be referred to as a second nozzle N and a third nozzle N. In addition, hereinafter, the discharge section D including the first nozzle N may be referred to as a first discharge section D, the discharge section D including the second nozzle N may be referred to as a second discharge section D, and the discharge section D including the third nozzle N may be referred to as a third discharge section D. The first discharge section D is an example of a "first discharge section", the second discharge section D is an example of a "second discharge section", and the third discharge section D is an example of a "third discharge section".

In addition, hereinafter, the discharge amount of ink from the first nozzle N when the second nozzle N and the third nozzle N discharge ink at the same timing as the first nozzle N may be referred to as a first discharge amount. The first discharge amount corresponds to, for example, the discharge amount of ink from the first nozzle N when the drive signal COMa is supplied to the first discharge section D, the second discharge section D, and the third discharge section D in the unit period Tu. In addition, hereinafter, the discharge amount of ink from the first nozzle N when the second nozzle N and the third nozzle N do not discharge the ink may be referred to as a second discharge amount. The second discharge amount corresponds to, for example, the discharge amount of ink from the first nozzle N when the drive signal COMa is supplied to the first discharge section D and the drive signal COMb is supplied to the second discharge section D and the third discharge section D in the unit period Tu. The first discharge amount is an example of a "first amount", and the second discharge amount is an example of a "second amount".

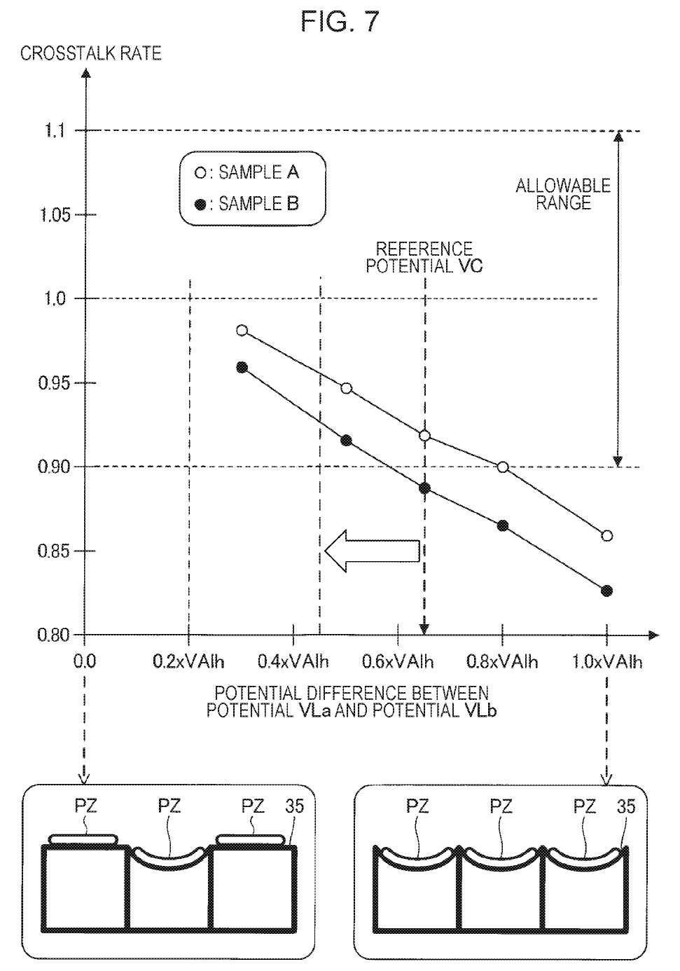

For example, the potential VLb is set so that the ratio of the second discharge amount to the first discharge amount is equal to or greater than 0.9 and equal to or less than 1.1. Hereinafter, the ratio of the second discharge amount to the first discharge amount may be referred to as a crosstalk rate. The variation in the discharge amount of the ink due to the structural crosstalk is smaller as the crosstalk rate is closer to 1. The relationship between the crosstalk rate and the potential VLb will be described later with reference to FIG. 7. In the present embodiment, at least, the potential of the drive signal COMb in the period corresponding to the period Ta of the waveform element Pa3 of the drive signal COMa is maintained by the waveform element Pb2, which will be described later, of the pulse PB at the potential VLb set so that the crosstalk rate is equal to or greater than 0.9 and equal to or less than 1.1. The period corresponding to the period Ta of the waveform element Pa3 is the period Ta of the waveform element Pa3 in the unit period Tu.

In the example illustrated in FIG. 5, the pulse PB includes the waveform elements Pb1 and Pb3 in addition to the waveform element Pb2.

The waveform element Pb1 is an expansion element after the waveform element Pb0. For example, in the waveform element Pb1, the potential of the drive signal COMb changes from the reference potential VC to the potential VLb to drive the piezoelectric element PZ so as to expand the volume of the pressure chamber CV. The waveform element Pb1 is an example of a "first potential change element". In addition, the displacement amount of the piezoelectric element PZ displaced by the waveform element Pb1 is an example of a "predetermined displacement amount".

The waveform element Pb2 is a maintenance element after the waveform element Pb1. In addition, in the waveform element Pb2, the potential of the drive signal COMb is maintained to drive the piezoelectric element PZ to maintain the volume of the pressure chamber CV expanded by the waveform element Pb1. Therefore, in the waveform element Pb2, the potential of the drive signal COMb is maintained at the potential VLb, which is the potential of the end point of the waveform element Pb1.

It is considered that maintaining the volume of the pressure chamber CV expanded by the waveform element Pb1 also can be understood as maintaining the displacement amount of the piezoelectric element PZ displaced by the waveform element Pb1. That is, in the present embodiment, the potential of the drive signal COMb is maintained at the potential VLb of the end point of the waveform element Pb1 so that the piezoelectric element PZ is maintained at the displacement amount of the piezoelectric element PZ displaced by the waveform element Pb1. The period Tb from the start point to the end point of the waveform element Pb2 includes the period Ta of the waveform element Pa3 of the drive signal COMa. Therefore, the waveform element Pb2 is an element that maintains the potential of the drive signal COMb so that the piezoelectric element PZ is maintained at a predetermined displacement amount in a period corresponding to the period Ta of the waveform element Pa3 of the drive signal COMa. The waveform element Pb2 is an example of the "first potential maintenance element".

The waveform element Pb3 is a contraction element after the waveform element Pb2. For example, in the waveform element Pb3, the potential of the drive signal COMb changes from the potential VLb to the reference potential VC to drive the piezoelectric element PZ to contract the volume of the pressure chamber CV maintained by the waveform element Pb2. The potential change rate of the waveform element Pb3 is set not to discharge the ink in the nozzle N. The potential change rate is the potential change amount per unit time. The waveform element Pb3 is an example of a "second potential change element".

As described above, the pulse PB is a pull-push waveform. However, the pulse PB is not limited to the pull-push waveform. In addition, as understood from FIG. 5, the waveform element Pb0 is an element before the waveform element Pb2, and the waveform element Pb4 is an element after the waveform element Pb2. In addition, the waveform element Pb1 is an element between the waveform element Pb0 and the waveform element Pb2, and the waveform element Pb3 is an element between the waveform element Pb2 and the waveform element Pb4.

Here, an interval TC from a center point tc1 of the period of the waveform element Pb1 to a center point tc2 of the period of the waveform element Pb3 is preferably in a range of at least 0.8 times and at most 1.2 times the natural vibration cycle of the discharge section D. The natural vibration cycle of the discharge section D is, for example, a natural vibration cycle representing the natural vibration cycle of M discharge sections D. For example, the natural vibration cycle representing the natural vibration cycle of the M discharge sections D may be the natural vibration cycle of one discharge section D among the M discharge sections D. Alternatively, the natural vibration cycle representing the natural vibration cycle of the M discharge sections D may be an average value of the natural vibration cycles of the K discharge sections D, or may be a maximum value or a minimum value of the natural vibration cycles of the K discharge sections D. The value K is a natural number satisfying "3 ≤ K ≤ M". In the present embodiment, a residual vibration due to the drive signal COMb can be suppressed by setting the interval TC in the range of at least 0.8 times and at most 1.2 times the natural vibration cycle of the discharge section D.

In addition, when the potential difference VAlc between the reference potential VC and the potential VLa is equal to or greater than 0.5 times the potential difference VAlh between the potential VLa and the potential VHa, the potential VLb of the waveform element Pb2 is preferably lower than the reference potential VC, and the potential difference VBlc between the reference potential VC and the potential VLb is preferably equal to or greater than 0.2 times the potential difference VAlh. In this case, the generation of the structural crosstalk can be suppressed while improving the discharge characteristic of the ink by increasing the reference potential VC.

For example, when the ink in the nozzle N can be stirred to such an extent that thickening is suppressed, the drive signal COMb also functions as a drive signal for stirring without discharging the ink in the nozzle N. The drive signal COMb may include, in order to stir the ink in the nozzle N, a pulse for stirring the ink in the nozzle N without discharging by applying the pressure fluctuation to the ink in the pressure chamber CV, in one or both of the front and rear of the pulse PB. In this case, since the ink in the nozzle N can be sufficiently stirred without discharging the ink in the nozzle N, the thickening of the ink can be suppressed.

An operation of the liquid discharge apparatus 1 is not limited to the example illustrated in FIG. 5. For example, separately from the drive signal COMb, the drive signal COM may include a drive signal for stirring the ink in the pressure chamber CV without discharging the ink in the nozzle N by applying the pressure fluctuation to the ink in the pressure chamber CV. In this case, since the ink in the nozzle N can be sufficiently stirred without discharging the ink in the nozzle N, the thickening of the ink can be suppressed. The drive signal COM for stirring without discharging the ink in the nozzle N may be supplied to the first discharge section D, for example, when the first discharge section D and the second discharge section D and the third discharge section D on both sides of the first discharge section D are the discharge sections D that do not discharge the ink. In this case, each of the second discharge section D and the third discharge section D may be supplied with the drive signal COM or the drive signal COMb for stirring without discharging the ink in the nozzle N, depending on whether or not the discharge section D disposed adjacent to the opposite side of the first discharge section D discharges the ink.

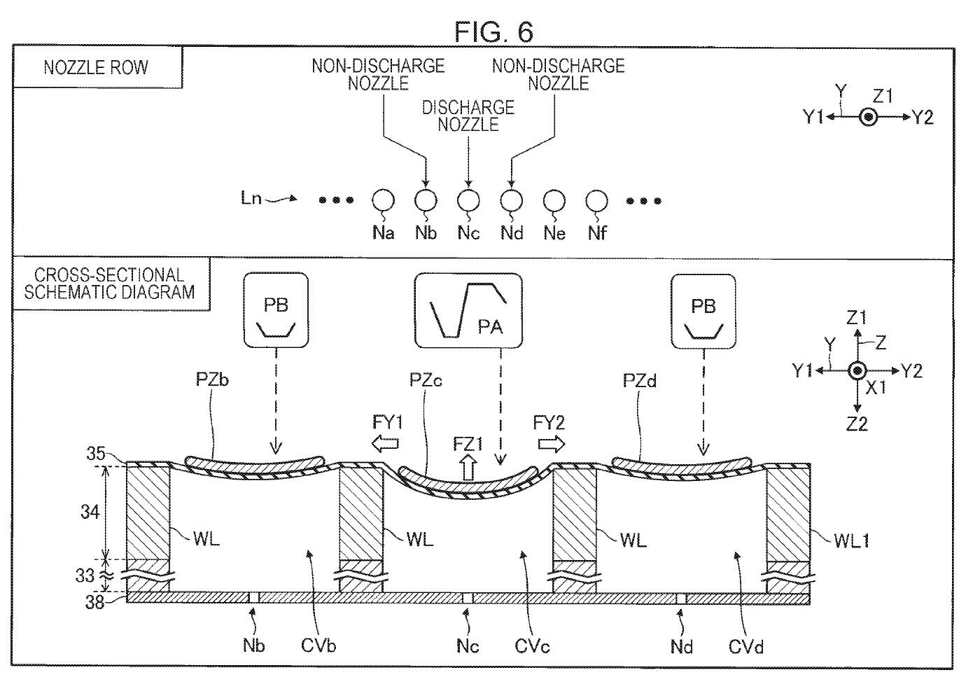

Next, the structural crosstalk will be briefly described with reference to FIG. 6.

FIG. 6 is an explanatory diagram for describing the structural crosstalk. In FIG. 6, in order to facilitate the explanation, alphabets "a", "b", "c", "d", "e", or "f" are added to the end of the reference numerals of the plurality of nozzles N included in the nozzle row Ln. In addition, an alphabet "b" is added to the end of each of the reference signs of the pressure chamber CV and the piezoelectric element PZ corresponding to the nozzle Nb. An alphabet "c" is added to the end of each of the reference signs of the pressure chamber CV and the piezoelectric element PZ corresponding to the nozzle Nc. An alphabet "d" is added to the end of each of the reference signs of the pressure chamber CV and the piezoelectric element PZ corresponding to the nozzle Nd.

In FIG. 6, as illustrated in the "nozzle row" in FIG. 6, it is assumed that the nozzle Nb and the nozzle Nd are non-discharge nozzles that do not discharge ink, and the nozzle Nc is a discharge nozzle that discharges ink. That is, in FIG. 6, the structural crosstalk in which the discharge characteristic of the nozzle Nc fluctuates depending on the discharge state of the nozzles Nb and Nd adjacent to both sides of the nozzle Nc will be briefly described. In FIG. 6, the discharge section D including the nozzle Nc corresponds to the "first discharge section", one of the two discharge sections D including the nozzles Nb and Nd corresponds to the "second discharge section", and the other of the two discharge sections D corresponds to the "third discharge section".

In the "cross-sectional schematic diagram" of FIG. 6, the piezoelectric element PZ and the like when only the nozzle Nc is driven to discharge ink among the three nozzles Nb, Nc, and Nd, are schematically illustrated. The piezoelectric element PZc is driven by the pulse PA, and the piezoelectric elements PZb and PZd are driven by the pulse PB. The structural crosstalk in which the discharge characteristic of the nozzle Nc fluctuates is generated, for example, by the relationship of the force generated in the discharge section D including the nozzle Nc fluctuating depending on the discharge state of the nozzles Nb and Nd and the like. For example, in the discharge section D including the nozzle Nc, a force FZ1 due to the rigidity of the piezoelectric element PZc itself and forces FY1 and FY2 due to the tension in which the piezoelectric elements PZb and PZd pull each other are generated. In this case, for example, the structural crosstalk is generated by the forces FY1 and FY2 fluctuating depending on the discharge states of the nozzles Nb and Nd. In addition, for example, the force FZ1 due to the rigidity of the piezoelectric element PZc itself is different depending on the head unit 3.

It is difficult to suppress the structural crosstalk generated by the forces FY1 and FY2 only by adjusting the pulse PA for discharging the ink from the nozzle N. Through experiments, the present inventors confirmed that the crosstalk rate changes as the potential VLb of the waveform element Pb2 of the drive signal COMb supplied to the discharge section D that does not discharge ink changes, as illustrated in FIG. 7. Therefore, in the present embodiment, as described above, the potential VLb is set so that the crosstalk rate is equal to or greater than 0.9 and equal to or less than 1.1.

FIG. 7 is an explanatory diagram for describing a relationship between the drive signal COMb supplied to the discharge section D that does not discharge ink and the crosstalk rate. FIG. 7 illustrates the results of an experiment performed using two head units 3 of sample A and sample B. The vertical axis of FIG. 7 illustrates a crosstalk rate, which is a ratio of the second discharge amount to the first discharge amount described in FIG. 5. A horizontal axis illustrates a potential difference of the potential VLb of the waveform element Pb2 of the drive signal COMb with respect to the potential VLa which is the potential of the start point of the waveform element Pa3 of the drive signal COMa. In FIG. 7, the potential difference between the potential VLa and the potential VLb is illustrated as a ratio with respect to the potential difference VAlh from the start point to the end point of the waveform element Pa3. For example, when the potential difference of the potential VLb with respect to the potential VLa is 1.0 times the potential difference VAlh, the potential VLb is the same potential as the potential VHa, which is the potential of the end point of the waveform element Pa3 of the drive signal COMa.

In addition, FIG. 7 schematically illustrates the piezoelectric element PZ and the like when the potential difference between the potential VLa and the potential VLb is 0.0 and when the potential difference between the potential VLa and the potential VLb is 1.0 times the potential difference VAlh. In sample A and sample B, the reference potential VC is set so that the potential difference VAlc of the reference potential VC with respect to the potential VLa is 0.65 times the potential difference VAlh.

As illustrated in FIG. 7, in sample A, when the potential VLb is set to the same potential as the reference potential VC, the crosstalk rate is brought within the allowable range which is equal to or greater than 0.9 and equal to or less than 1.1. On the other hand, in sample B, when the potential VLb is set to the same potential as the reference potential VC, the crosstalk rate is less than 0.9, which is out of the allowable range. As described above, the head unit 3 causes the difference in the crosstalk rate. It is considered that the difference is generated because the tension of the piezoelectric element PZ is different depending on the configuration of the head unit 3 such as the configuration of the piezoelectric element PZ. As illustrated in FIG. 7, by changing the potential VLb, the crosstalk rate can be changed to be larger than the difference in the crosstalk rate generated by the difference in the head unit 3. That is, by appropriately setting the potential VLb, the crosstalk rate can be brought within the allowable range.

In the example illustrated in FIG. 7, the crosstalk rate is greater as the potential VLb is lower. For example, when the potential VLb is set so that the potential difference between the potential VLa and the potential VLb is 0.2 times the potential difference VAlh, the crosstalk rate of both sample A and sample B is a value close to 1.0.

As understood from FIG. 7, for example, when the potential VLb is set so that the potential difference between the potential VLa and the potential VLb is equal to or less than 0.45 times the potential difference VAlh, the crosstalk rate of both sample A and sample B is brought within the allowable range with a margin. That is, when the potential VLb is set so that the potential difference VBlc between the reference potential VC and the potential VLb is equal to or greater than 0.2 times the potential difference VAlh, the crosstalk rate of both sample A and sample B is brought within the allowable range with a margin. Here, in the drive signal COMa for discharging the ink, when the reference potential VC is increased, the ink discharge characteristic tends to be improved. Therefore, for example, it is preferable to set the reference potential VC so that the potential difference VAlc with the potential VLa is equal to or greater than 0.5 times the potential difference VAlh, and to set the potential VLb so that the potential difference VBlc with the reference potential VC is equal to or greater than 0.2 times the potential difference VAlh.

For example, when the potential VLb is set to the same potential as the reference potential VC in order to bring the crosstalk rate within the allowable range which is equal to or greater than 0.9 and equal to or less than 1.1, at least during the period Ta of the waveform element Pa3 of the drive signal COMa, the drive signal COMb is maintained at the potential VLb which is the same potential as the reference potential VC. In this case, the drive signal COMb may be maintained at the potential VLb which is the same as the reference potential VC in the unit period Tu. Alternatively, the drive signal COMb may be maintained at the potential VLb which is the same as the reference potential VC in the period Ta of the waveform element Pa3 of the drive signal COMa, and may have a pulse for generating minute vibration to suppress the thickening of the ink in the period other than the period Ta.

In addition, depending on the configuration of the head unit 3 and the setting of the reference potential VC, when the potential VLb is set to the same potential as the reference potential VC, it may be considered that the crosstalk rate is greater than 1.1, which is the upper limit of the allowable range. In this case, the crosstalk rate can be brought within the allowable range by setting the potential VLb to a potential higher than the reference potential VC.

As described above, in the present embodiment, the generation of structural crosstalk can be suppressed by setting the potential VLb of the waveform element Pb2 of the drive signal COMb supplied to the discharge section D that does not discharge ink to be brought within the allowable range of the crosstalk rate which is equal to or greater than 0.9 and equal to or less than 1.1.

As described above, in the present embodiment, the liquid discharge apparatus 1 includes the head unit 3 having the plurality of discharge sections D each including the nozzle N that discharges ink, the pressure chamber CV that communicates with the nozzle N, and the piezoelectric element PZ that applies the pressure fluctuations to the ink in the pressure chamber CV in accordance with the drive signal COM, and the drive signal generation unit 4 that generates the drive signal COM. The plurality of discharge sections D include the first discharge section D, the second discharge section D positioned adjacent to one side of the first discharge section D, and the third discharge section D positioned adjacent to the other side of the first discharge section D. The drive signal COM includes the drive signal COMa supplied to the discharge section D that discharges the ink from the nozzle N and the drive signal COMb supplied to the discharge section D that does not discharge the ink from the nozzle N. The drive signal COMa includes the waveform element Pa3 which is an element of potential change for displacing the piezoelectric element PZ so that the ink is discharged from the nozzle N. The drive signal COMb includes the waveform element Pb2 that maintains the potential so that the piezoelectric element PZ is maintained at a predetermined displacement amount in a period corresponding to the period Ta of the waveform element Pa3. When the drive signal COMa is supplied to the first discharge section D, the second discharge section D, and the third discharge section D in the unit period Tu, a first amount of ink is discharged from the nozzle N of the first discharge section D. When the drive signal COMa is supplied to the first discharge section D and the drive signal COMb is supplied to the second discharge section D and the third discharge section D in the unit period Tu, the second amount of ink is discharged from the nozzle N of the first discharge section D. The potential VLb of the waveform element Pb2 is set so that the ratio of the second amount to the first amount is equal to or greater than 0.9 and equal to or less than 1.1.

As described above, in the present embodiment, the drive signal COMb includes the waveform element Pb2 that maintains the potential so that the piezoelectric element PZ is maintained at a predetermined displacement amount in the period corresponding to the period Ta of the waveform element Pa3. The potential VLb of the waveform element Pb2 is set to have a ratio of the second amount to the first amount which is equal to or greater than 0.9 and equal to or less than 1.1. As a result, in the present embodiment, the difference can be suppressed in the discharge amount of the ink from the first nozzle N depending on whether or not the nozzles N adjacent to both sides of the first nozzle N among the plurality of nozzles N discharge the ink at the same timing as the first nozzle N. That is, in the present embodiment, the generation of the structural crosstalk can be suppressed.

In addition, in the present embodiment, the drive signal COMb may further include the waveform element Pb0 which is an element before the waveform element Pb2 and maintains the potential at the reference potential VC from the start of the unit period Tu, the waveform element Pb4 which is an element after the waveform element Pb2 and maintains the potential at the reference potential VC until the end of the unit period Tu, the waveform element Pb1 which is an element between the waveform element Pb0 and the waveform element Pb2 and of which the potential changes from the reference potential VC to the potential VLb of the waveform element Pb2, and the waveform element Pb3 which is an element between the waveform element Pb2 and the waveform element Pb4 and of which the potential changes from the potential VLb of the waveform element Pb2 to the reference potential VC. In this case, the interval TC between the center point tc1 of the period of the waveform element Pb1 and the center point tc2 of the period of the waveform element Pb3 may be in a range of at least 0.8 times and at most 1.2 times the natural vibration cycle of the discharge section D. When the interval TC is in the range of at least 0.8 times and at most 1.2 times the natural vibration cycle of the discharge section D, the residual vibration can be suppressed by the drive signal COMb.

Further, in the present embodiment, the drive signal COMa may include the waveform element Pa0 which is an element before the waveform element Pa3 and maintains the potential at the reference potential VC from the start of the unit period Tu, the waveform element Pa1 which is an element between the waveform element Pa0 and the waveform element Pa3, of which the potential changes from the reference potential VC to the potential VLa, and which expands the volume of the pressure chamber CV, the waveform element Pa2 which is an element between the waveform element Pa1 and the waveform element Pa3 and maintains the potential at the potential VLa from the end point of the waveform element Pa1 to the start point of the waveform element Pa3, and the waveform element Pa6 which is an element after the waveform element Pa3 and maintains the potential at the reference potential VC until the end of the unit period Tu. The reference potential VC is a potential between the potential VLa and the potential VHa, which is the potential of the end point of the waveform element Pa3. The potential difference VAlc between the reference potential VC and the potential VLa may be equal to or greater than 0.5 times the potential difference VAlh between the potential VLa and the potential VHa, the potential VLb of the waveform element Pb2 may be a potential lower than the reference potential VC, and the potential difference VBlc between the reference potential VC and the potential VLb of the waveform element Pb2 may be equal to or greater than 0.2 times the potential difference VAlh between the potential VLa and the potential VHa. In the present aspect, the interval TC is not particularly limited. In the present aspect, the generation of the structural crosstalk can be suppressed while improving the discharge characteristic of the ink by increasing the reference potential VC.

In the present embodiment, the drive signal COM may further include a drive signal for stirring the ink in the nozzle N without discharging the ink in the nozzle N by applying the pressure fluctuation to the ink in the pressure chamber CV. In this case, since the ink in the nozzle N can be sufficiently stirred without discharging the ink in the nozzle N, the thickening of the ink can be suppressed.

### 2. Modification Example

Each embodiment above can be variously modified. Specific modification aspects are illustrated below. Two or more aspects selected in any manner from the following examples can be combined with each other as appropriate within a range not inconsistent with each other. In addition, in the modification examples described below, elements having the same effects and functions as those of the embodiment will be given the reference numerals used in the description above, and each detailed description thereof will be omitted as appropriate.

### First Modification Example

In the above-described embodiment, a case where the liquid discharge apparatus 1 has four head units 3 is exemplified, but the present disclosure is not limited to such an aspect. For example, the liquid discharge apparatus 1 may have one or more and three or less head units 3, or may have five or more head units 3. Also in the present modification example, the same effect as in the embodiment described above can be obtained.

### Second Modification Example

In the above-described embodiment and modification example, a case where the liquid discharge apparatus 1 is a serial printer is exemplified, but the present disclosure is not limited to such an aspect. For example, the liquid discharge apparatus 1 may be a so-called line printer in which the plurality of nozzles N are provided in the head unit 3 to extend wider than the width of the recording paper sheet PP. In the present modification example as well, the same effect as in the embodiment and modification examples described above can be obtained.

### Third Modification Example

In the embodiment and modification example described above, a case is described as an example in which the piezoelectric element PZ is displaced in the Z2 direction by changing a potential of the individual drive signal Vin[m] from a low potential to a high potential, and the present disclosure is not limited to such an aspect. For example, the piezoelectric element PZ that is displaced in the Z2 direction by the potential of the individual drive signal Vin[m] changing from the high potential to the low potential may be used. In this case, for example, the potential of the drive signal COM is changed from the low potential to the high potential in a portion corresponding to an expansion element, and is changed from the high potential to the low potential in a portion corresponding to a contraction element. In the present modification example as well, the same effect as in the embodiment and modification examples described above can be obtained.

### 3. Appendices

From the embodiments described above, for example, the following configuration can be ascertained.

A liquid discharge apparatus according to a first aspect which is a preferred aspect, includes a liquid discharge head that includes a plurality of discharge sections each having a nozzle that discharges a liquid, a pressure chamber which communicates with the nozzle, and a piezoelectric element which applies a pressure fluctuation to a liquid in the pressure chamber according to a drive signal; and a drive signal generation section that generates the drive signal, in which the plurality of discharge sections include a first discharge section, a second discharge section positioned adjacent to one side of the first discharge section, and a third discharge section positioned adjacent to another side of the first discharge section, the drive signal includes a first drive signal supplied to a discharge section that discharges a liquid from the nozzle, and a second drive signal supplied to a discharge section that does not discharge a liquid from the nozzle, the first drive signal includes a discharge element that is an element of potential change for displacing the piezoelectric element so that a liquid is discharged from the nozzle, the second drive signal includes a first potential maintenance element that maintains a potential so that the piezoelectric element is maintained at a predetermined displacement amount in a period corresponding to a period of the discharge element, in a unit period, a first amount of liquid is discharged from the nozzle of the first discharge section when the first drive signal is supplied to the first discharge section, the second discharge section, and the third discharge section, in the unit period, a second amount of liquid is discharged from the nozzle of the first discharge section when the first drive signal is supplied to the first discharge section and the second drive signal is supplied to the second discharge section and the third discharge section, and a potential of the first potential maintenance element is set so that a ratio of the second amount to the first amount is equal to or greater than 0.9 and equal to or less than 1.1.

According to the first aspect, the generation of the structural crosstalk can be suppressed.

In a liquid discharge apparatus according to a second aspect which is a specific example of the first aspect, the second drive signal further includes a start potential maintenance element that is an element before the first potential maintenance element and maintains a potential at a reference potential from a start of the unit period, an end potential maintenance element that is an element after the first potential maintenance element and maintains the potential at the reference potential until an end of the unit period, a first potential change element that is an element between the start potential maintenance element and the first potential maintenance element and of which a potential changes from the reference potential to the potential of the first potential maintenance element, and a second potential change element that is an element between the first potential maintenance element and the end potential maintenance element and of which a potential changes from the potential of the first potential maintenance element to the reference potential, and an interval from a center point of a period of the first potential change element to a center point of a period of the second potential change element is in a range which is equal to or greater than 0.8 times and equal to or less than 1.2 times a natural vibration cycle of the discharge section.

According to the second aspect, the residual vibration due to the second drive signal can be suppressed.

In a liquid discharge apparatus according to a third aspect which is a specific example of the first aspect, the first drive signal further includes a first start potential maintenance element that is an element before the discharge element and maintains a potential at a reference potential from a start of the unit period, an expansion element that is an element between the first start potential maintenance element and the discharge element, of which a potential changes from the reference potential to a first potential, and that expands a volume of the pressure chamber, an expansion maintenance element that is an element between the expansion element and the discharge element and maintains the potential at the first potential from an end point of the expansion element to a start point of the discharge element, and a first end potential maintenance element that is an element after the discharge element and maintains the potential at the reference potential until an end of the unit period, the second drive signal further includes a second start potential maintenance element that is an element before the first potential maintenance element and maintains the potential at the reference potential from the start of the unit period, a second end potential maintenance element that is an element after the first potential maintenance element and maintains the potential at the reference potential until the end of the unit period, a first potential change element that is an element between the second start potential maintenance element and the first potential maintenance element, and of which a potential changes from the reference potential to the potential of the first potential maintenance element, and a second potential change element that is an element between the first potential maintenance element and the second end potential maintenance element, and of which a potential changes from the potential of the first potential maintenance element to the reference potential, the reference potential is a potential between the first potential and a second potential which is a potential of an end point of the discharge element, a potential difference between the reference potential and the first potential is equal to or greater than 0.5 times a potential difference between the first potential and the second potential, the potential of the first potential maintenance element is a potential lower than the reference potential, and a potential difference between the reference potential and the potential of the first potential maintenance element is equal to or greater than 0.2 times the potential difference between the first potential and the second potential.

According to the third aspect, the generation of the structural crosstalk can be suppressed while improving the discharge characteristic of the liquid by increasing the reference potential.

In a liquid discharge apparatus according to a fourth aspect which is a specific example of the third aspect, an interval from a center point of a period of the first potential change element to a center point of a period of the second potential change element is in a range which is equal to or greater than 0.8 times and equal to or less than 1.2 times a natural vibration cycle of the discharge section.

According to the fourth aspect, the generation of structural crosstalk can be suppressed while improving the discharge characteristic of the liquid by increasing the reference potential, and the residual vibration due to the second drive signal can be suppressed.

In a liquid discharge apparatus according to a fifth aspect which is a specific example of any one of the first to fourth aspects, the drive signal further includes a third drive signal for stirring the liquid in the nozzle without discharging by applying the pressure fluctuation to the liquid in the pressure chamber.

According to the fifth aspect, since the ink in the nozzle N can be sufficiently stirred without discharging the ink in the nozzle N, the thickening of the ink can be suppressed.

A control method of a liquid discharge apparatus according to a sixth aspect which is a preferable aspect, is a control method of a liquid discharge apparatus including a liquid discharge head that includes a plurality of discharge sections each having a nozzle that discharges a liquid, a pressure chamber which communicates with the nozzle, and a piezoelectric element which applies a pressure fluctuation to a liquid in the pressure chamber according to a drive signal, and a drive signal generation section that generates the drive signal, in which the plurality of discharge sections include a first discharge section, a second discharge section positioned adjacent to one side of the first discharge section, and a third discharge section positioned adjacent to another side of the first discharge section, in which the drive signal includes a first drive signal supplied to a discharge section that discharges a liquid from the nozzle, and a second drive signal supplied to a discharge section that does not discharge a liquid from the nozzle, the first drive signal includes a discharge element that is an element of potential change for displacing the piezoelectric element so that a liquid is discharged from the nozzle, the second drive signal includes a first potential maintenance element that maintains a potential so that the piezoelectric element is maintained at a predetermined displacement amount in a period corresponding to a period of the discharge element, in a unit period, a first amount of liquid is discharged from the nozzle of the first discharge section when the first drive signal is supplied to the first discharge section, the second discharge section, and the third discharge section, in the unit period, a second amount of liquid is discharged from the nozzle of the first discharge section when the first drive signal is supplied to the first discharge section and the second drive signal is supplied to the second discharge section and the third discharge section, and a potential of the first potential maintenance element is set so that a ratio of the second amount to the first amount is equal to or greater than 0.9 and equal to or less than 1.1.

According to the sixth aspect, the same effect as in the first aspect can be obtained.

In a control method of a liquid discharge apparatus according to a seventh aspect which is a specific example of the sixth aspect, the second drive signal further includes a start potential maintenance element that is an element before the first potential maintenance element and maintains a potential at a reference potential from a start of the unit period, an end potential maintenance element that is an element after the first potential maintenance element and maintains the potential at the reference potential until an end of the unit period, a first potential change element that is an element between the start potential maintenance element and the first potential maintenance element and of which a potential changes from the reference potential to the potential of the first potential maintenance element, and a second potential change element that is an element between the first potential maintenance element and the end potential maintenance element and of which a potential changes from the potential of the first potential maintenance element to the reference potential, and an interval from a center point of a period of the first potential change element to a center point of a period of the second potential change element is in a range which is equal to or greater than 0.8 times and equal to or less than 1.2 times a natural vibration cycle of the discharge section.

According to the seventh aspect, the same effect as in the second aspect can be obtained.

In a control method of a liquid discharge apparatus according to an eighth aspect, which is a specific example of the sixth aspect, the first drive signal further includes a first start potential maintenance element that is an element before the discharge element and maintains a potential at a reference potential from a start of the unit period, an expansion element that is an element between the first start potential maintenance element and the discharge element, of which a potential changes from the reference potential to a first potential, and that expands a volume of the pressure chamber, an expansion maintenance element that is an element between the expansion element and the discharge element and maintains the potential at the first potential from an end point of the expansion element to a start point of the discharge element, and a first end potential maintenance element that is an element after the discharge element and maintains the potential at the reference potential until an end of the unit period, the second drive signal further includes a second start potential maintenance element that is an element before the first potential maintenance element and maintains the potential at the reference potential from the start of the unit period, a second end potential maintenance element that is an element after the first potential maintenance element and maintains the potential at the reference potential until the end of the unit period, a first potential change element that is an element between the second start potential maintenance element and the first potential maintenance element, and of which a potential changes from the reference potential to the potential of the first potential maintenance element, and a second potential change element that is an element between the first potential maintenance element and the second end potential maintenance element, and of which a potential changes from the potential of the first potential maintenance element to the reference potential, the reference potential is a potential between the first potential and a second potential which is a potential of an end point of the discharge element, a potential difference between the reference potential and the first potential is equal to or greater than 0.5 times a potential difference between the first potential and the second potential, the potential of the first potential maintenance element is a potential lower than the reference potential, and a potential difference between the reference potential and the potential of the first potential maintenance element is equal to or greater than 0.2 times the potential difference between the first potential and the second potential.

According to the eighth aspect, the same effect as in the third aspect can be obtained.

In a control method of a liquid discharge apparatus according to a ninth aspect which is a specific example of the eighth aspect, an interval from a center point of a period of the first potential change element to a center point of a period of the second potential change element is in a range which is equal to or greater than 0.8 times and equal to or less than 1.2 times a natural vibration cycle of the discharge section.

According to the ninth aspect, the same effect as in the fourth aspect can be obtained.

In a control method of a liquid discharge apparatus according to a tenth aspect, which is a specific example of any one of the sixth to ninth aspects, the drive signal further includes a third drive signal for stirring the liquid in the nozzle without discharging by applying the pressure fluctuation to the liquid in the pressure chamber.

According to the tenth aspect, the same effect as in the fifth aspect can be obtained.

What is claimed is:

1. A liquid discharge apparatus comprising:
a liquid discharge head that includes a plurality of discharge sections each having a nozzle that discharges a liquid, a pressure chamber which communicates with the nozzle, and a piezoelectric element that is configured to apply a pressure fluctuation to a liquid in the pressure chamber according to a drive signal; and
a drive signal generation section that is configured to generate the drive signal, wherein
the plurality of discharge sections include a first discharge section, a second discharge section positioned adjacent to one side of the first discharge section, and a third discharge section positioned adjacent to another side of the first discharge section,
the drive signal includes
a first drive signal supplied to a discharge section that discharges a liquid from the nozzle, and
a second drive signal supplied to a discharge section that does not discharge a liquid from the nozzle,
the first drive signal includes a discharge element that is an element of potential change for displacing the piezoelectric element so that a liquid is discharged from the nozzle,
the second drive signal includes a first potential maintenance element that maintains a potential so that the piezoelectric element is maintained at a predetermined displacement amount in a period corresponding to a period of the discharge element,
in a unit period, a first amount of liquid is discharged from the nozzle of the first discharge section when the first drive signal is supplied to the first discharge section, the second discharge section, and the third discharge section,
in the unit period, a second amount of liquid is discharged from the nozzle of the first discharge section when the first drive signal is supplied to the first discharge section and the second drive signal is supplied to the second discharge section and the third discharge section, and
a potential of the first potential maintenance element is set so that a ratio of the second amount to the first amount is equal to or greater than 0.9 and equal to or less than 1.1.

2. The liquid discharge apparatus according to claim 1, wherein
the second drive signal further includes
a start potential maintenance element that is an element before the first potential maintenance element and maintains a potential at a reference potential from a start of the unit period,
an end potential maintenance element that is an element after the first potential maintenance element and maintains the potential at the reference potential until an end of the unit period,
a first potential change element that is an element between the start potential maintenance element and the first potential maintenance element and of which a potential changes from the reference potential to the potential of the first potential maintenance element, and
a second potential change element that is an element between the first potential maintenance element and the end potential maintenance element and of which a potential changes from the potential of the first potential maintenance element to the reference potential, and
an interval from a center point of a period of the first potential change element to a center point of a period of the second potential change element is in a range which is equal to or greater than 0.8 times and equal to or less than 1.2 times a natural vibration cycle of the discharge section.

3. The liquid discharge apparatus according to claim 1, wherein
the first drive signal further includes
a first start potential maintenance element that is an element before the discharge element and maintains a potential at a reference potential from a start of the unit period,
an expansion element that is an element between the first start potential maintenance element and the discharge element, of which a potential changes from the reference potential to a first potential, and that expands a volume of the pressure chamber,
an expansion maintenance element that is an element between the expansion element and the discharge element and maintains the potential at the first potential from an end point of the expansion element to a start point of the discharge element, and
a first end potential maintenance element that is an element after the discharge element and maintains the potential at the reference potential until an end of the unit period,
the second drive signal further includes
a second start potential maintenance element that is an element before the first potential maintenance element and maintains the potential at the reference potential from the start of the unit period,
a second end potential maintenance element that is an element after the first potential maintenance element and maintains the potential at the reference potential until the end of the unit period,
a first potential change element that is an element between the second start potential maintenance element and the first potential maintenance element, and of which a potential changes from the reference potential to the potential of the first potential maintenance element, and
a second potential change element that is an element between the first potential maintenance element and the second end potential maintenance element, and of which a potential changes from the potential of the first potential maintenance element to the reference potential,
the reference potential is a potential between the first potential and a second potential which is a potential of an end point of the discharge element,
a potential difference between the reference potential and the first potential is equal to or greater than 0.5 times a potential difference between the first potential and the second potential,
the potential of the first potential maintenance element is a potential lower than the reference potential, and
a potential difference between the reference potential and the potential of the first potential maintenance element is equal to or greater than 0.2 times the potential difference between the first potential and the second potential.

4. The liquid discharge apparatus according to claim 1, wherein
the drive signal further includes a third drive signal for stirring the liquid in the nozzle without discharging by applying the pressure fluctuation to the liquid in the pressure chamber.

5. A control method of a liquid discharge apparatus including a liquid discharge head that includes a plurality of discharge sections each having a nozzle that discharges a liquid, a pressure chamber which communicates with the nozzle, and a piezoelectric element that is configured to apply a pressure fluctuation to a liquid in the pressure chamber according to a drive signal, and a drive signal generation section that is configured to generate the drive signal, in which the plurality of discharge sections include a first discharge section, a second discharge section positioned adjacent to one side of the first discharge section, and a third discharge section positioned adjacent to another side of the first discharge section, the method including:
supplying a first drive signal included in the drive signal to a discharge section that discharges a liquid from the nozzle, the first drive signal includes a discharge element that is an element of potential change for displacing the piezoelectric element so that a liquid is discharged from the nozzle,
in a unit period, a first amount of liquid is discharged from the nozzle of the first discharge section when the first drive signal is supplied to the first discharge section, the second discharge section, and the third discharge section,
supplying a second drive signal included in the drive signal to a discharge section that does not discharge a liquid from the nozzle,
the second drive signal includes a first potential maintenance element that maintains a potential so that the piezoelectric element is maintained at a predetermined displacement amount in a period corresponding to a period of the discharge element,
in the unit period, a second amount of liquid is discharged from the nozzle of the first discharge section when the first drive signal is supplied to the first discharge section and the second drive signal is supplied to the second discharge section and the third discharge section, and
a potential of the first potential maintenance element is set so that a ratio of the second amount to the first amount is equal to or greater than 0.9 and equal to or less than 1.1.
